(19) United States
(12) Patent Application Publication
(10) Pub. No.: US 2016/0179103 A1
(43) Pub. Date: Jun. 23, 2016

(54) Device for locally regulating the delivery of gas in response to environmental variables

(71) Applicant: Michel Paradis, New York, NY (US)

(72) Inventor: Michel Paradis, New York, NY (US)

(21) Appl. No.: 14/580,201

(22) Filed: Dec. 22, 2014

(51) Int. Cl. G05D 7/06; F01D 5/02; F01D 17/10; F01D 15/00

(52) U.S. Cl. CPC G05D 7/0617; F01D 15/00; F01D 5/02; F01D 17/10; F05D 2220/70; F05D 2240/24; F05D 2260/42

(57) ABSTRACT

This device attaches onto or is integrated into the existing outlet connections of a gas source and dynamically regulates the flow of gases through an electronically controlled valve in response to environmental variables. The device uses circuitry that has been calibrated to open and close the valve automatically when the device's sensor array detects environmental variables in quantities or patterns that it has been programmed to associate with the need to terminate or initiate a gas flow.

### CROSS REFERENCE TO RELATED APPLICATIONS

The present application claims the benefit of previously filed co-pending Provisional Patent Application Ser. #61/922,911.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

A variety of industrial processes and medical therapies depend on the safe delivery of gases into dynamic environments. The presence of certain environmental variables often requires that delivery of the gases to be regulated, in particular where environmental variables create hazards that are imperfectly mitigated by human intervention.

One of the most common examples is the oxygen (LOX) that flows throughout hospitals and from the increasingly portable LOX tanks given to patients with cardiovascular and pulmonological conditions. In the presence of fire, a continuous flow of pure oxygen can have devastating consequences. While the oxygen itself is not flammable, it significantly increases a fire's rate of combustion. Consequently, patients with LOX tanks are given detailed warnings about avoiding open flames whilst operating their tanks, including the flames incident to smoking and cooking.

Patients, however, show poor long-term compliance with such warnings. In fact, the present invention was inspired by a recent tragedy, where a patient at the University of Maryland Medical Center died after igniting his hospital bed with a cigarette. According to reports, this fire spread faster and was made more difficult to extinguish by the oxygen cannula running to his nose. Similar incidents have resulted from individual's portable LOX tanks, which pose additional risks given that individuals carry them into environments that present significant fire hazards.

Simply stated, the local delivery of otherwise inert or beneficial gases often needs to be locally regulated when local environmental variables change. Human error, slow reaction times, and negligence collectively call out for an automated solution that is low-cost, locally implemented, and minimally disruptive to the ordinary operation of diverse gas delivery systems.

The present invention is in the technical field of mechanical engineering. More particularly, the present invention is in the technical field of mechatronics, valves, and systems control.

The present invention is novel and non-obvious because no device like this is commercially available and it fills a significant gap left by the prior art. To the extent the prior art has sought to solve this problem at all, it has been through systems, methods, and devices that are either cumbersome or non-portable, that lack automatic local control, that must be implemented as complex systems, that are responsive only to problems within the gas delivery system itself, such as leaks, or that are not responsive to dynamic conditions. At present, there is no solution that is portable, that dynamically regulates gas flow in response to environmental variables, and that can be fitted with minimal disruption onto the standard outlet connections from which gas is ordinarily delivered into the environment.

Most emergency shutoff valves that rely on electronic sensors are integrated into large-scale structures, such as homes or office buildings. U.S. Pat. No. 6,989,757 B2 discloses a carbon monoxide protection system that connects carbon monoxide detectors in the structure to a control module, central alarm, and off-site monitoring station, which can terminate the source of carbon monoxide. U.S. Pat. No. 6,662,821 B2 discloses a system and method for closing the existing water valve that runs into a structure in response to a leak, the system being composed of fluid detector, a transmitter connected to the fluid detector, a receiver to receive signals from the transmitter detecting the presence of a leak within a building or structure, and a motorized actuator that can be retrofitted onto the gas/fluid lines running into the structure. U.S. Pat. No. 6,199,573 B1 discloses a device and method for shutting off the flow of gas to a structure, such that when a fire detector within the structure emits a signal to an actuator that closes the valves connecting the structure to the gas lines when a fire is detected. U.S. Pat. No. 5,975,105 discloses a seismic actuator for initiating various actions in response to seismic activity that is mechanically detected above predetermined threshold level. U.S. Pat. No. 5,823,223 discloses a mechanical valve attachment that terminates the flow of gas through the gas meter of a house during seismic events or in response to other significant vibrations. US 2006/0191323 A1 discloses a system for detecting gas leaks within buildings, whereby sensors are installed throughout the buildings and connected to radio transmitters that send signals to a controller that performs actions such as selectively closing or opening valves and electrical connections as well as notifying the building's owners or occupants. U.S. Pat. No. 6,661,346 B1 discloses a system for integrating seismometers, gas leak, and fire detection sensors into the construction of a building and closing the gas valves running into the building in response to hazardous signals.

Other systems have employed networked sensors to monitor and control valves across multiple points along a large-scale gas/liquid delivery system. U.S. Pat. No. 8,072,343 B2 discloses a local logic solver that operates with a local smart valve, outputting a local indication of trouble with the valve to a control panel for the process, which is mounted in the field away from the facility's central servers and can be operated by a local technician. U.S. Pat. No. 7,928,852 B2, U.S. Pat. No. 7,145,467 B2, U.S. Pat. No. 6,987,448 B2, and U.S. Pat. No. 7,768,414 B2 disclose methods and systems for managing a medical gas system within a hospital or similar facility by using wireless sensors and transmitters located at each point of use that transmit data to a central server. U.S. Pat. No. 6,994,309 B2 discloses a method of powering a remote controlled transmitter and safety valve with the mechanical energy generated by the turning of a gas meter's flow measurement rotors. U.S. Pat. No. 3,747,618 discloses an automatic shut-off valve system for oil wells and the like including an in-line positive shut-off valve located aft of a well head in line with the main pipeline to a hydrocarbon reservoir within the earth, equipped with various sensing devices such that any dangerous environment existing in the general area of the well head will effectuate a complete and positive shut-off of the hydrocarbon flow. U.S. Pat. No. 7,199,721 B2 discloses a smoke detector that contains a transmitter that sends a radio signal to a second device that automatically disconnects the electrical and natural gas lines running into household appliances. US20060191323 A1 discloses a system for detecting gas leaks within buildings, where by sensors are installed throughout the buildings and connected to radio transmitters that send signals to a controller that performs actions such as selectively closing or opening valves and electrical connections as well as notifying the building's owners or occupants. U.S. Pat. No. 5,057,822 discloses a system wherein a sensor detects a high or low pressure condition in the supply line of medical gas, the signal is received by an alarm module and an alarm is activated to notify external monitors. U.S. Pat. No. 3,521,481 discloses a valve leak detector that is positioned downstream of one or more valves in a row line to indicate a leak in any one by closing each valve one at a time.

As is clear from most of the prior art described thus far, most systems, methods, and devices designed to automatically shutoff a liquid/gas flow are intended to respond to flaws within the delivery system itself, such as leaks. In addition to those cited above, WO2013106690 discloses an automatic valve shutoff device and methods that close a valve in the presence of a leak, involving an actuator configured to be activated using an activation signal; and a valve attachment portion configured for attaching the actuator to an existing valve, wherein the actuator, once activated, is operable to turn the existing valve via the valve attachment portion. U.S. Pat. No. 6,025,788 discloses a system, which mounts on to a valve handle or actuator that closes the valve when external sensors detect undesirable liquid and/or gas leaks. U.S. Pat. No. 6,021,808 discloses a system for monitoring the pressure within a liquid storage tank and initiating a shut-off valve for the tanks inlet when the pressure within the tank drops below a predetermined threshold. U.S. Pat. No. 5,967,171 discloses a motorized actuator mounted on a mechanical water valve, which closes the valve stem when a water leak is detected downstream from the valve. U.S. Pat. No. 5,144,973 discloses a safety valve for compressed gas cylinders that terminates a gas flow from the cylinder when a primary gas valve attached to the cylinder port of the cylinder is severed. U.S. Pat. No. 4,921,008 discloses an emergency gas flow shutoff device for use primarily with a gas cylinder, which uses pressure sensors to detect a sudden loss of resistance downstream of the device to trigger the closure of the valve. U.S. Pat. No. 4,000,754 discloses an automatic control valve for fluid systems that automatically closes the valve when an excessive flow rate occurs. U.S. Pat. No. 3,941,145 discloses a safety valve for pressure fluid flow lines and which may be utilized in combination with a punch tee, said valve being responsive to pressure differentials acting thereacross for automatically closing to preclude accidental loss of pressure fluid from the line. US27675816 discloses a leak detection system wherein a sensor samples the air adjacent to a gas utilizing device and another device closes the gas valve when the sensors detected an ambient gas concentration indicative of a leak.

Even when systems, methods, or devices aim to control fluid and gas delivery on the basis of inputs external to the delivery system, they have sought to regulate flow by installing mechanical devices that manipulate an existing valve's actuator or stem. In addition to the prior art discussed above, U.S. Pat. No. 5,588,637 discloses an automatic gas valve shut off system that attaches directly on the valve stem of an application-sized compressed gas cylinder. The invention generally contemplates the use of a microprocessor connected to a motor that turns the valve stem in response to actuation signals from external sensors. U.S. Pat. No. 7,059,338 B1 discloses a system whereby a programmable electronic controller provides an emergency actuation signal to a motorized valve stem actuator upon receiving an emergency close signal and a gas detection input that can send emergency close signals to the controller in the presence of a gas leak. U.S. Pat. No. 5,694,960 discloses a valve actuating apparatus that mounts to existing household gas cooking or plug valves, ones that are opened and closed with a quarter turn, and uses compressed CO2 to trigger an alarm and the automatic termination of the gas flow when sensors detect the presence of fire or of hazardous or toxic gases, such as carbon monoxide, propane, methane, hydrogen and the like. U.S. Pat. No. 7,066,192 B1 discloses a valve shutoff device that attaches directly to existing valve handles through the use of adapters and when its sensor detects a leaking substance, the device triggers a motor unit that turns the valve handle to the closed position. U.S. Pat. No. 8,256,742 B2 discloses a sensor and powered valve actuator assembly that can be fitted to a valve handle and operates the manual valve and which can close the valve in response to a predetermined triggering event.

The only devices designed to fit onto existing outlet connections have had limited or highly specialized functionality. U.S. Pat. No. 2,812,806 and U.S. Pat. No. 3,447,880 disclose variations on systems whereby the pilot valve of a gas burner is controlled by circuitry that automatically triggers the closure of the valve when a sensor detects the absence of a flame U.S. Pat. No. 6,733,276 B1 and US20060118181 A1 disclose variations on a shut-off device that attaches to the valve ports of a gas grill or stove and terminates the gas flow at the expiration of a timer.

### SUMMARY OF THE INVENTION

The present invention is a device that is installed onto or integrated into the valve ports or outlet connections of a gas source. The device contains its own electronically controlled valve, which is operated by the device's internal circuitry. The device's circuitry integrates the inputs from one or more sensors, which are connected to the device and detect environmental variables proximate to the outlet of the device. The device's circuitry then automatically regulates the flow of gas out from the device's outlet valve port in response to these environmental variables.

### BRIEF DESCRIPTION OF THE DRAWINGS

FIG. 1 illustrates an exterior view of a broad embodiment of the present invention.

FIG. 2 illustrates a pseudo-schematic overlay on FIG. 1 indicating the necessary internal components of the invention.

FIG. 3 illustrates an embodiment of the invention, specifically the integration of the invention into a nasal cannula.

FIG. 3a is an enlarged sectional view of a pseudo-schematic overlay illustrating FIG. 3's sensor array (14).

FIG. 3b is an enlarged sectional view of a pseudo-schematic overlay illustrating FIG. 3's circuitry (31), valve (28), and power supply (29).

### DETAILED DESCRIPTION OF THE INVENTION

Referring now to the invention in more detail, in broad embodiment, the present invention is composed of four essential components: a) a sensor array, comprised of at least one sensor, calibrated to detect known environmental variables, b) an electronically controlled valve, c) electronic circuitry to integrate the input from the sensor array and to regulate the flow of gases through the valve, and d) a power supply.

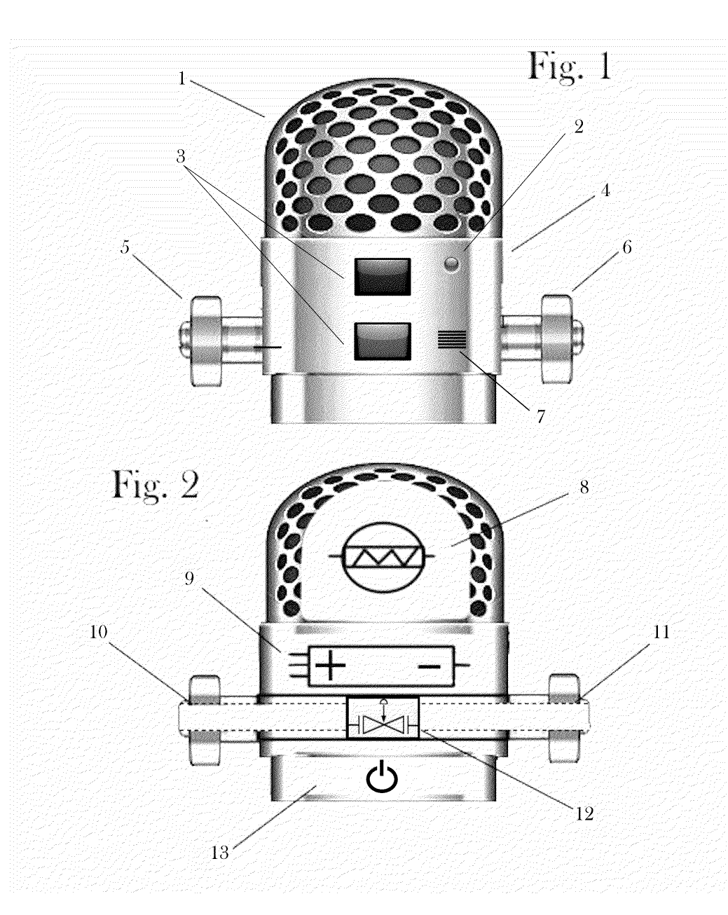

FIG. 1 shows an exterior view of a broad embodiment of the invention in order to illustrate its functionality and necessary components. The embodiment illustrated in FIG. 1 includes a permeable enclosure for the sensor array (1), an enclosure for the invention's flow regulation components (4), the outlet valve port (5,10) and the inlet valve port (6,11) through which gas flows. As shown, the embodiment illustrated in FIG. 1 includes optional controls (3) that allow a user to manually open and close the valve, calibrate the circuitry, and reset the device after the valve (12) has been actuated in response to an environmental condition. As shown, the embodiment illustrated in FIG. 1 also includes an optional indicator light (2) to signal whether the valve (12) is open or closed as well as a speaker (7) that emits a tone indicating that the device has actuated its valve (12).

In more detail, FIG. 2 shows a pseudo-schematic overlay of FIG. 1 in order to illustrate the invention's four essential internal components: the sensor array (8), the circuitry (9), the valve (12), and the power supply (12). The sensor array (8) detects the presence of environmental variables that affect the desired gas flow. The input from the sensor array (8) is integrated by the invention's circuitry (9), which is calibrated to correlate the local environmental data with the desired gas flow. This is done by automatically adjusting the throughput of the valve (12) in response to changes in the environmental variables detected by the sensor array (8) as gas flows into the inlet valve port (6,11) and out to the outlet valve port (5,10). The device relies on a local power supply (13) that powers the sensor array (8), the circuitry (9), and the actuation of the valve (12).

In further detail, still referring to the embodiment of the invention illustrated in FIGS. 1 and 2, the size of a particular embodiment is dictated by the size of the sensors that comprise the sensor array (8), the type of fittings that must be connected into the inlet (6,11) and outlet (5,10) valve ports, the physical stress of the environment on the components, and the composition of the power supply. While the invention claimed is defined by the combination of its four essential components irrespective of size, a major benefit of the present invention compared to the prior art is that it is small and lightweight enough to be connected onto the existing valve and cannula fittings used in most gas delivery systems. For example, as shown, the embodiment illustrated in FIGS. 1 and 2 measures less than 75 millimeters high and weighs less than 100 grams. This ensures that it can be directly attached to the kinds of outlet connections typically found on portable compressed gas tanks or the walls of hospital rooms, thereby requiring the most minimal modification of the existing gas flow system.

Still referring to the embodiment of the invention as shown in FIGS. 1 and 2, the enclosure shown in FIG. 1 is fabricated from a thin aluminum screen (1) to cover the sensor array (8) and solid aluminum plates (4) to cover the remaining components. The screen (1) in FIG. 1 need only be permeable enough to allow ambient environmental conditions to be detected by the enclosed sensor array. A few openings in an otherwise solid enclosure may, therefore, be sufficient for the purposes of some embodiments. Any solid and moldable material can be used to construct these enclosures. The valves and associated piping in typical gas delivery systems are constructed of brass or aluminum. The inlet (6,11) and outlet (5,10) valve ports as well as the valve (12) must therefore be constructed of a suitably solid material so that the device forms a tight seal and is durable.

The construction of the sensor array (8) is customized to the particular environmental variables to which the valve (12) and circuitry (9) should be responsive. As shown, the sensor array (8) is symbolized as resistors, although the particular type of sensors is not essential to the invention. Indeed, depending on the application, more complex sensors, such as spectrometers, ionizing and photoelectric smoke detectors, optical air-samplers, etc., may be appropriate and can be integrated into the sensor array (8).

The valve (12) must be constructed to reliably open and close in response to electrical signals sent from the circuitry (9). As shown, the valve (12) is symbolized as a fail-closed actuated valve, although the precise valve-type is not essential to the invention. Solenoid or motor operated valves can also be sufficient for most purposes. Likewise, since the embodiment illustrated in FIGS. 1 and 2 is designed to be able to terminate the flow of gas in the presence of environmental hazards such as fire, the valve (12) is fail-closed to ensure that a disruption of the circuitry (9) or power supply (13) results in the gas flow's termination by default.

The complexity of the circuitry (9) is dictated by the complexity and multiplicity of the environmental variables detected by the sensor array (8). Simple embodiments wherein the sensor array (8) contains only a single or few sensors, for example, can rely on simple analog circuits that trigger the opening/closure of the valve (12) in response to the sensors having detected certain environmental variables beyond certain preset thresholds. As the number of sensors in the sensor array (8) increases, however, microcontrollers can be used to regulate the valve (12) and respond to user inputs. The calibration of the circuitry (9) can, in turn, be calibrated to account for user feedback, such as raising or lowering the threshold for the automatic opening/closure of the valve (12). For example, the circuitry (9) can be calibrated to err on the side of closing the valve (12) if it can be reopened easily. The circuitry (9) can also operate indicator lights (2), sonic alarms (7), or other user interfaces as desired.

The construction of the power supply (13) is dictated by considerations of weight, reliability, portability, and size. For embodiments designed to be portable and/or to protect against rare but catastrophic events, a small, replaceable battery is likely sufficient to power the invention's essential components when needed. For embodiments that are anticipated to routinely adjust the valve (12) in response to frequent changes in environmental variables, a steadier power supply (13), such as a power plug or a solar panel, can be preferable. For embodiments where the intended use anticipates that the valve (12) will regularly remain in the open position, the power supply (13) can be supplemented by suitably sized turbines that exploit the continuous gas flow from the inlet (6,11) to the outlet (5,10) valve ports in order to turn a rotor and thereby charge a local battery or capacitor contained within the power supply (13), insofar as doing so does not excessively disrupt the gas pressure required by the user at the outlet valve port (5,10).

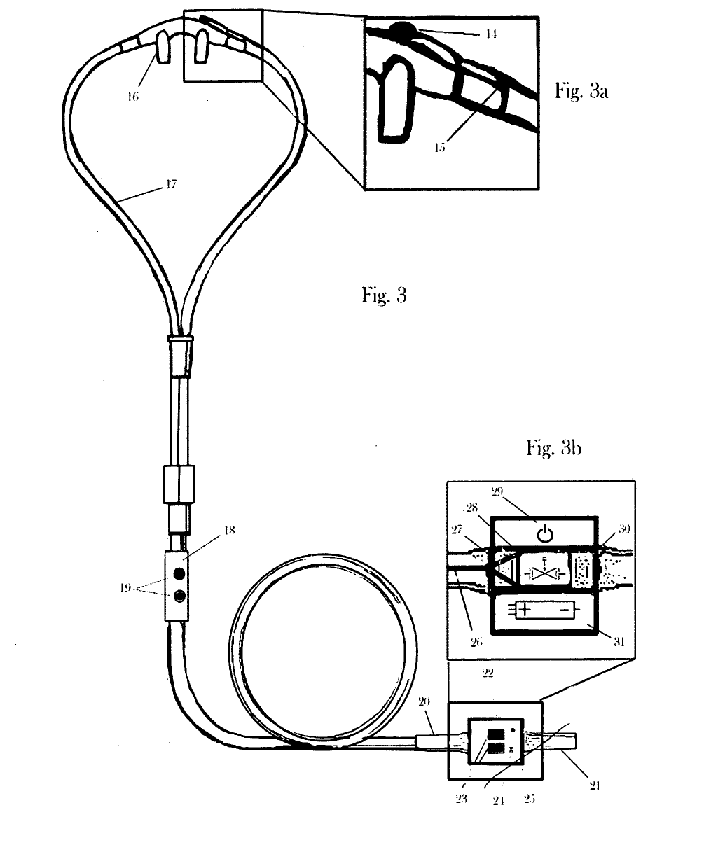

FIG. 3 shows a specialized embodiment of the invention, whereby portions of the sensor array (14) are integrated into the kind of nasal cannula used to deliver supplemental oxygen to patients with pulmonological conditions. As shown, the nasal cannula has the traditional components of prongs (16), which are inserted into a patient's nose, connected to hosing (17), which connects to a gas source via a luer fitting (20) at the device's outlet valve port (27). As shown, the embodiment illustrated in FIG. 3 terminates the gas flow into the cannula in the presence of hazards, such as combustion.

In more detail, this embodiment as shown positions the sensor array (14) near the prongs (16) of the cannula in order to detect those environmental variables that are most proximate to the output of the gas into the environment. This is illustrated in FIG. 3a, which is an enlarged sectional view of FIG. 3's sensor array (14) located at the prongs (16) of the cannula. The sensor array (14) then connects via an insulated cable (15,26) that runs along the cannula's hosing (17) to the circuitry (31), which controls the valve (28) and regulates the gas flow to the prongs (16) of the cannula. If the sensor array (14) is calibrated to detect the presence of combustion and the input to the circuitry (31) from the sensor array (14) indicates the presence of that hazard, for example, the circuitry (31) triggers the closure of the valve (28), thereby terminating the gas flow and lowering the rate of combustion proximate to the prongs (16) of the cannula. The optional user controls (19, 23) allow for user feedback, such as open, close, and reset buttons, so that a user can manually signal the circuitry (31) to open or close the valve (31). Though not essential to the invention, this feature enables the user to reset the device in cases of false positives or after the hazard has been eliminated.

In further detail, still referring to the embodiment of the invention as shown in FIG. 3, the sensor array (14) must be as light as possible in order to avoid undue strain on the patient's head, ears, and neck, as well as the tubing (17) of the cannula, which could pull the prongs (16) from the patient's nose if the sensor array is too heavy. In the embodiment shown, the sensor array weighs about 1 gram. The valve (28) will ordinarily have an internal radius of 0.25″-0.75″ to match the standard luer fittings in use today. The circuitry (31) and power supply (29) should be sized down to fit the necessary components into the enclosure (22). In the embodiment shown, the enclosure (22) measures less than 50 cubic millimeters and weighs less than 150 grams.

To construct the embodiment of the invention shown in FIG. 3 as shown, the prongs (16) and hosing (17) of the nasal cannula are made from lightweight non-latex plastic. The cannula's luer fitting (20) has a molded plastic shell with a brass core that connects into the brass inlet (30) and outlet (27) valve ports. The enclosure (22) is constructed of thin aluminum to minimize its weight and protect the interior components, but a lightweight metal, plastic, or composite material can also serve this purpose.

The construction of the sensor array (14) is dictated by the weight of the sensors and the durability of the cannula. As shown, the sensor array (14) is positioned to the right prong (16) of nasal cannula. When calibrated to detect combustion, for example, the sensor array could include a thermistor and photoresistor in order to detect sudden increases in heat and light in the environment near the patient's face. Depending on the number, sizes, and weight of the sensors included in the sensor array (14), it can be preferable to distribute the sensors across the front of the prongs (16), at other points along the cannula's hosing (17), or on the enclosure (22), as it is in FIGS. 1 and 2. The placement of the sensors should optimally detect the environmental signatures of hazards, distribute the weight of the sensor array (14), and eliminate the influence of confounds that would affect the precision of the sensor array (14). For example, thermistors that are located too close to the prongs (16) will be less sensitive to changes in ambient temperature due to their proximity to the patient's exhaled breath.

As shown, the sensor array (14) is connected to the circuitry (31) and power supply (29) that control the valve (28) via an insulated cable (15,26) that is attached to the cannula's hosing (17). The nasal cannula's luer fitting (20) connects to the outlet valve port (27), which connect the cannula to the valve (28). The inlet valve port (30) connects the valve (28) to the gas source via its native outlet connection (27).

The valve (28), circuitry (31), and power supply (29) are housed in a separate enclosure (22) that is illustrated with a pseudo-schematic overlay on the enlarged sectional view in FIG. 3b. As shown, the enclosure (22) containing the valve (28) also has an optional speaker (24) and indicator light (25) to alert the user when the device has been activated. The valve (28), circuitry (31), and power supply (29) are constructed as described in relation to the embodiment illustrated in FIGS. 1 and 2.

As shown, redundant user controls (19) connect to the circuitry (31) in order to reliably transmit user feedback, such as to open or close the valve, to the device. These redundant controls can be placed on a lightweight plastic enclosure (18) located at a convenient distance along the hosing (17) from the patient's hands in addition to the controls (23) co-located on or near the enclosure (22) containing the valve (28), which will often prove more accessible to a patient's caretaker.

The advantages of the present invention include, without limitation, the ability to automatically regulate local gas flows based on environmental variables with minimal interference with the ordinary operation of a gas delivery system. The present invention exceeds the prior art by being locally and autonomously controlled, thereby allowing for a degree of portability and flexibility not possible with systems that depend on central servers to centrally control valves or require substantial installation costs. The present invention connects directly to the existing inlet and outlet fittings of a gas delivery system, thereby making it lighter, cheaper, and more widely compatible than the devices that attempt to mechanically actuate an existing valve. The present invention offers low cost and ease of use. By compensating for human error, slow reaction times, and inattention, the present invention enables gases to flow into dynamic environments with greater safety and convenience than would otherwise be possible.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

I claim:

1. A device for locally regulating the flow of gases into dynamic environments in response to environmental variables proximate to the device, comprising:
a. A sensor array, comprised of at least one sensor,
b. A valve,
c. Circuitry that evaluates at least one input from the sensor array and operates the opening and closure of the valve, and
d. A power supply.

2. A device, as set forth in claim 1, which affixes onto the existing valve ports or outlet connections of a gas source.

3. A device, as set forth in claim 1, which includes user-operated buttons or controls to open, close, modulate, and/or reset the valve.

4. A device, as set forth in claim 1, which includes user-operated buttons or controls to calibrate the circuitry to open, close, modulate, and/or reset the valve in response to environmental variables detected by the sensor array in certain quantities, combinations, or patterns.

5. A device, as set forth in claim 1, wherein its components are included within a single enclosure.

6. A device, as set forth in claim 1, wherein some or all of its components are located within different enclosures.

7. A device, as set forth in claim 1, wherein the power supply is charged by a local turbine whose rotor is turned by the flow of gas through the device when the valve is open.

8. A device, as set forth in claim 1, with a digital transmitter and/or receiver to send/receive data, calibration instructions, or operating commands to the circuitry to/from a central server.

9. A device, as set forth in claim 1, wherein the sensor array and circuitry are calibrated to detect the presence of fire and/or combustion and the circuitry triggers the closure of the valve in order to terminate the flow of oxygen or flammable gases into the environment.

10. A device, as set forth in claim 1, wherein the sensor array is affixed or otherwise integrated into the cannula used to deliver oxygen or flammable gases into the environment.
